(19) United States
(12) Patent Application Publication
(10) Pub. No.: US 2009/0253474 A1
(43) Pub. Date: Oct. 8, 2009

(54) Reflexing deflector-elements for automatically discarding, from a combine harvester, oversized wads of harvest residue

(76) Inventor: Nathan E. Isaac, Lancaster, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/080,365

(22) Filed: Apr. 2, 2008

(51) Int. Cl. A01F 12/00

(52) U.S. Cl. 460/111; 460/149

(57) ABSTRACT

A vertical spreader of a combine harvester has a reflexing deflector elements hingedly secured to a flow guide element, and the deflectors are reinforced by over-center linkage so as to automatically hinge in response to the positive pressure of an oversized wad of crop residue and/or by loss of impeller speed. The wad is thereby discarded, and the deflector elements thereafter return to the original position held prior to hinging.

### TECHNICAL FIELD

This invention relates generally to an agricultural combine and to a vertical spreader therefor, which is operable for discharging a flow of straw and/or other crop residue from the combine. More particularly, this invention relates to deflector plates located, generally, intermediately adjacent to counter-rotating impellers within the vertical spreaders. The deflector plates serve to receive and to direct the flow of crop residue from the spreader.

### BACKGROUND ART

In the past, combines have typically included, or had associated therewith, crop residue spreaders for discarding (onto the field from which the crop is being harvested) straw, chaff, and other residue separated while harvesting the crop. Some combines have even employed a special spreader solely for spreading chaff residue. Earlier spreaders, in many instances, exhibited uneven distribution of the crop residue resulting in a heavier concentration being distributed at the center of the overall swath, but a lighter concentration being distributed sidewardly. Such uneven distribution resulted in various problems including but not limited to, difficulty in passing tillage tools through residue clumps on the field, uneven insulation of the field (resulting in uneven field warming and thawing), uneven crop emergence during subsequent planting seasons, and increased infestations of rodents and insects inhabiting the uneven crop residuals. Consequently, a variety of devices were developed to enable more desirable flow-patterns from crop residue spreaders, vis-á-vis improved flow guide elements.

However, until now, there has been no accommodation for handling wads of crop material, caught in the residue spreader, prior to discharge. For example, weeds, cockleburs, corncobs, roots, chunks of bean stalks, which tend to be more supple, are less likely to be chopped up during threshing. Such materials can occasionally agglomerate or wad up, and stall the motor or otherwise cause excessive overloading. This leads to premature damage to impeller tips, excessive wear at the point of discharge, and distorted discharge flow patterns, and stalling from plugging up of the entire spreader with crop residue, beginning at the impellers. Correcting this problem without weakening the structural integrity of the guide elements used for flow distribution, would result in energy savings, e.g., by enabling use of lower horsepower motors, greater fuel efficiency and/or more efficient lubrication protocols. Additional savings, inuring from the improved lifetime of the moving parts, would be a welcomed advancement in combine harvester design.

Although prior art flow guide elements have been adjustable, the deflector plates which extend from the flow guides have been immovable, during discharge, except by command of the operator, when moving the flow guides and deflectors as a single unit. Uniting the movements of the guide element and deflector elements was believed essential in order to achieve the predetermined flow distribution patterns for the discarded crop residue, even though wads of residue may be entrapped therebetween.

Accordingly, there has been a longstanding need for a means of dislodging the wadded residue from the crop residue spreader, without adversely distorting the predetermined discharge patterns, and without having to manually dislodge such wads.

### SUMMARY OF THE INVENTION

I have herein disclosed, in satisfaction of a longfelt need in my industry, vertical spreaders, having reflexing deflector plates. The plates are united with the guide element and rigidly affixed, except when a predetermined threshold force, of agglomerating, wedged, or wadded residue exerts itself against the surface of the deflector plates. The deflector plates, as a direct consequence of the threshold force, will swing, spring, flex, hinge or move away from the central guide element, increasing the deflector's clearance or distance from the impeller, discarding the wadded material, and thereafter the deflector plates will immediately return to their original fixed positions integral with the guide element.

Each deflector plate is preferably hinged at its interface with a flow guide element, and the deflector plates are preferably spring-loaded via over-center linkage elements. The linkage elements inhibit the hinged deflector plates from freely moving downwardly from the flow guide element, except in response to the threshold force of a wad clump or oversized particle of crop residue. As a consequence of the linkage's construction and spring-like bias, a reflex action, automatically returns the plate to and stops it at, its original position, leaving a sufficient clearance to allow the generally adjacent impeller to rotate unimpededly. The over-center linkages may comprise mechanical springs, hydraulic pistons, or other responsive devices, including, for example, electronic activators and sensors triggering the deflector to hinge away under positive pressure while discarding the wad, but return instantly thereafter in controlled fashion to its original position. The following detailed description, preferred embodiments, and the drawings will illustrate the invention and give rise to contemplated embodiments of the invention, including alternative configurations of components, such as flow guide elements, couplings, connectors, adjustable mechanisms, springs, sensors, stops, deflector plates, leaf springs as substitutes for or in addition to hinges, all of which are within contemplation of this invention. Further and more complete understanding can be derived from or will become apparent from these details and the appended claims.

### BRIEF DESCRIPTION OF THE DRAWINGS

FIG. 1 is a simplified fragmentary side view of a representative combine harvester, having a crop residue distribution system including a dual impeller spreader at the bottom of its rear end;

FIG. 2 is a direct view of the spreader's dual counter-rotating impellers and intermediate flow guide elements as seen from the rear of the combine harvester;

FIG. 3 is a direct partial view of the left impeller and an associated flexing deflector element being reinforced against the intermediate flow guide element, by a spring-loaded, piston-type, over-center linkage;

FIG. 4 is a disassembled view of the spring-loaded piston-type, over-center linkage of FIG. 3;

FIG. 5 is a direct partial view of the left impeller and an associated flexing deflector element, being reinforced against the flow guide element by a spring-loaded, rocker-type, over-center linkage;

FIG. 6 is a disassembled perspective view of the rocker-type, over-center linkage of FIG. 5;

FIG. 7 is a diagram of the flexing deflector element and over-center linkage in FIG. 5 at the resting or home position; and

FIG. 8 is a diagram of the flexing deflector element and over-center linkage of FIG. 5 when in the flexed position in response to the positive pressure of, for example, a wad of crop material to be discarded.

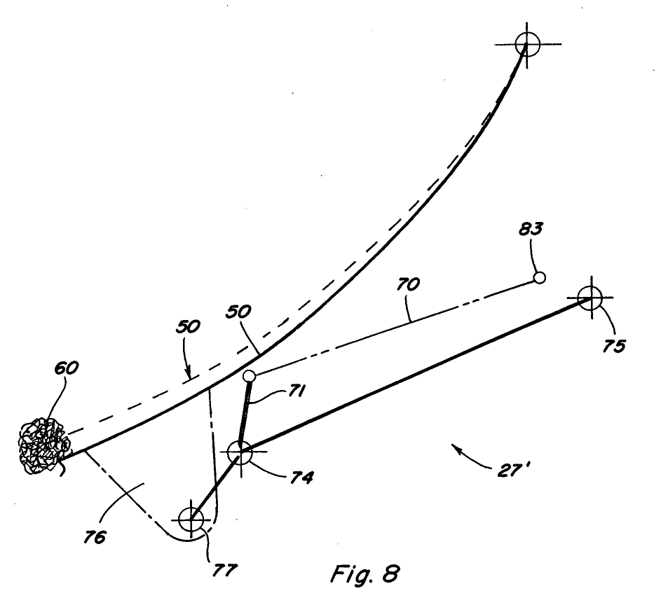

### DETAILED DESCRIPTION OF THE INVENTION

The preferred embodiments of the present invention are depicted in the drawings, wherein like numerals refer to like items, and wherein prime designations in conjunction with a numeral, for example, 38′ and 38″, identify variations of the element designated by the numeral.

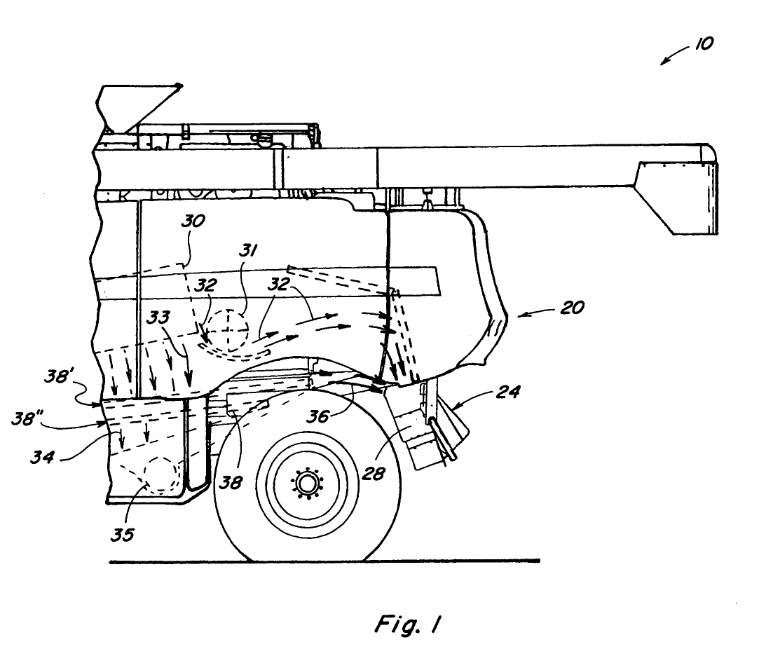

FIG. 1 depicts a rear end 20 of a self-propelled combine harvester 10, including a vertical crop residue spreader 24 operable for spreading straw, stalks, or other refuge, all referred to as crop residue 32 that has been separated from the grain of the crops by a threshing mechanism 30 located forwardly of rear end 20. The crop residue 32 is propelled rearwardly by rotating beaters 31 as residue 32 exits from the threshing mechanism 30. In the case of harvesting, for example, wheat, the grain and chaff mixture 33, unlike crop residue 32, fall onto the chaffer 38′ and the sieve 38″ of the cleaning system 38. The clean grain 34 is sifted from the mixture of grain and chaff 33, and falls onto the auger 35, while the lighter material or chaff 36, which remains after sifting the mixture 33, is blown by a fan (not shown) back into the spreader 24 along with the heavier straw-type crop residue 32.

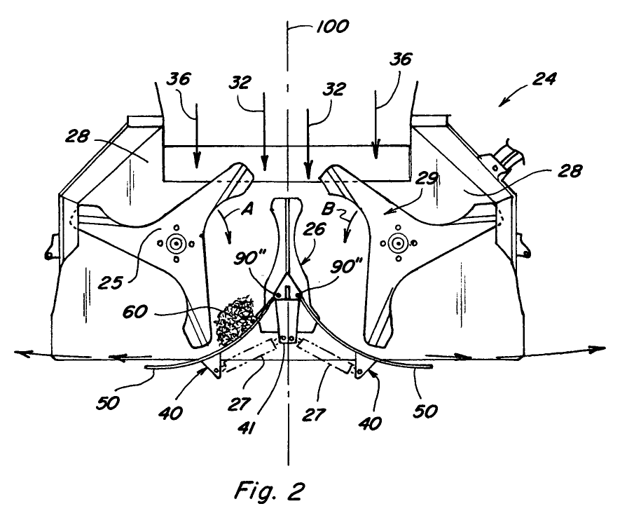

Referring now to FIG. 2, two streams comprising chaff residue 36 and straw-type crop residue 32, flow into the top of spreader 24 and are propelled by the counter-rotating impellers 25 and 29 into predetermined rotational directions A and B, which rotations also define the circumferential profiles of the impellers 25 and 29 and the attendant circumferential flow paths of the crop residue 32 and 36. The circumferentially flowing crop residues revolve at rates of speed equal to or greater than the inlet rate of speed of the residues 32 and 36, but nevertheless may agglomerate into or contain, for example, wad 60, which may stall or strain, for example, impeller 25 or its attendant motor (not shown). Flow guide element portion 26 of spreader 24 abuts against the back sheet 28. The flow guide element 26 is preferably constructed of rigid construction material, such as sheet metal, or rigid plastic, suitable for receiving flowing crop material. Laterally extending deflector elements 50 (which may be sheets, plates, ribs, forked-members or the like) project outwardly from the flow guide 26 in arcuate profiles to match the circumferential profiles of the impellers 25 and 29. Over-center piston-type spring linkages 27 are biased between yoke connections 41 and stop connections 40, to reinforce the deflector element 50 against freely hinging at yoke 41 or at hinges 90′ or 90″, absent positive pressure at a threshold level.

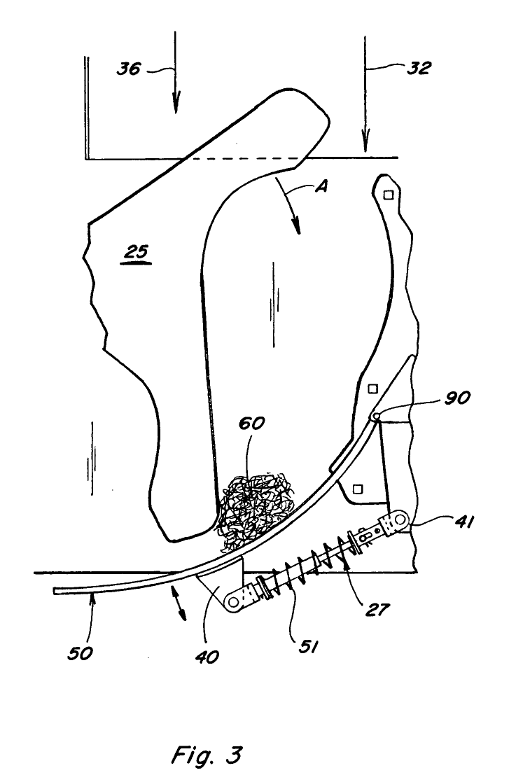

As illustrated in FIG. 3, the residue streams 32 and 36, when propelled by impeller 25 rotating in direction A may gather into or contain a wad 60. Wad 60, rather than stalling impeller 25, creates sufficient pressure to pivot deflector plate 50 downwardly, from hinge 90, so as to increase the clearance between impeller 25 and plate 50, and against the bias of spring element 51 on the over-center piston-type linkage 27. Wad 60 is thereby discharged, after which deflector plate 50 returns back to its original position, by virtue of the spring 57 recoiling and returning piston-type linkage 27 to its original length.

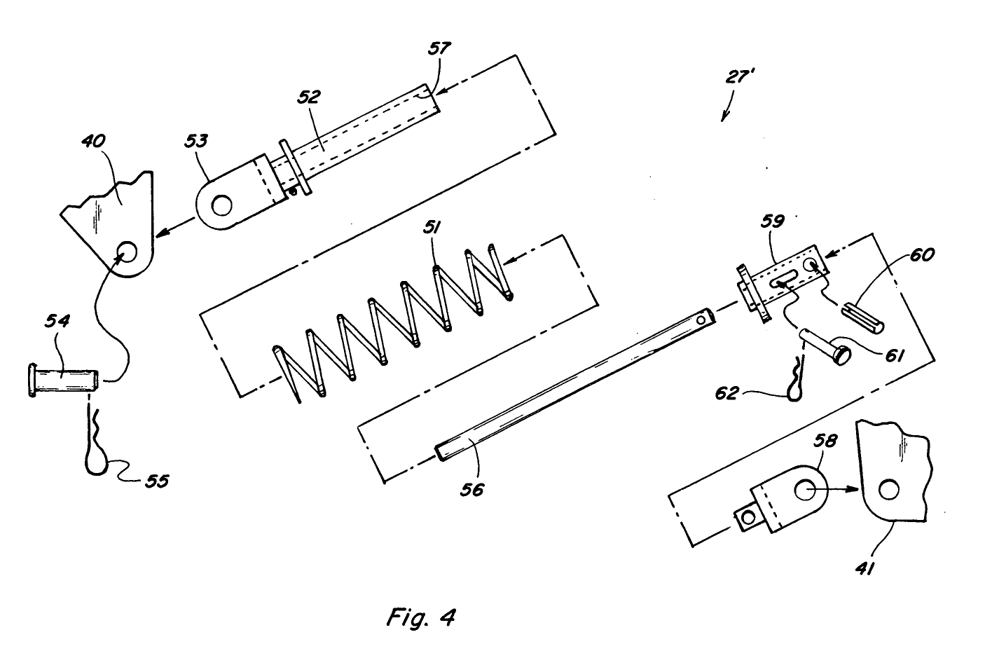

As may be seen in FIG. 4, spring 51 telescopically coils around piston element guide chamber 52 having a hollow bore 57 through its length until it abuts a stop end 53. Stop end 53 hingedly connects at stop 40 so as to hinge about pin 54, while being secured by presto pin 55. Piston 56 provides piston-like action by sliding lengthwise within bore 57 of piston element guide 52. Rod 56 sliding action is abutted at stop end 53 and its opposite end is hingedly secured at yoke support 41 by yoke 58. Yoke 58 extends from its hinge at support 41 at one end, to a smaller end, fitting within a central bore in collar 59 which slideably receives piston rod 56. Roll pin 60 hingedly secures yoke 58 to collar 59. Pin 61 and presto pin 62 secure rod 56 slideably within collar 59.

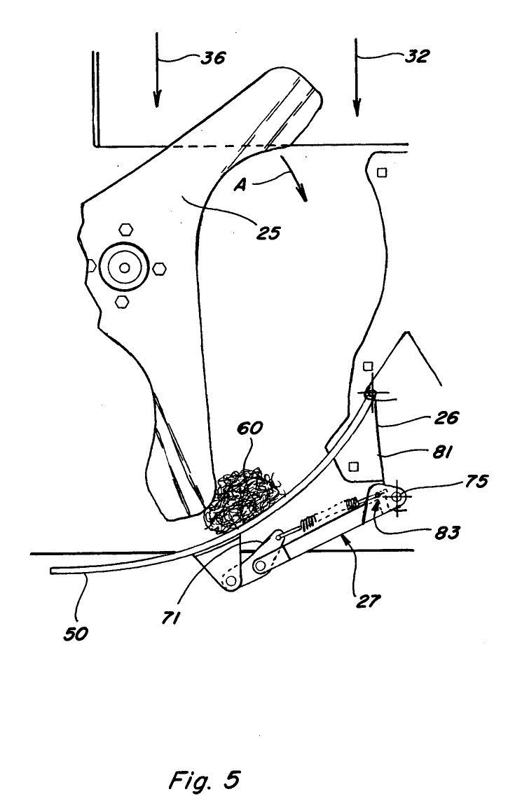

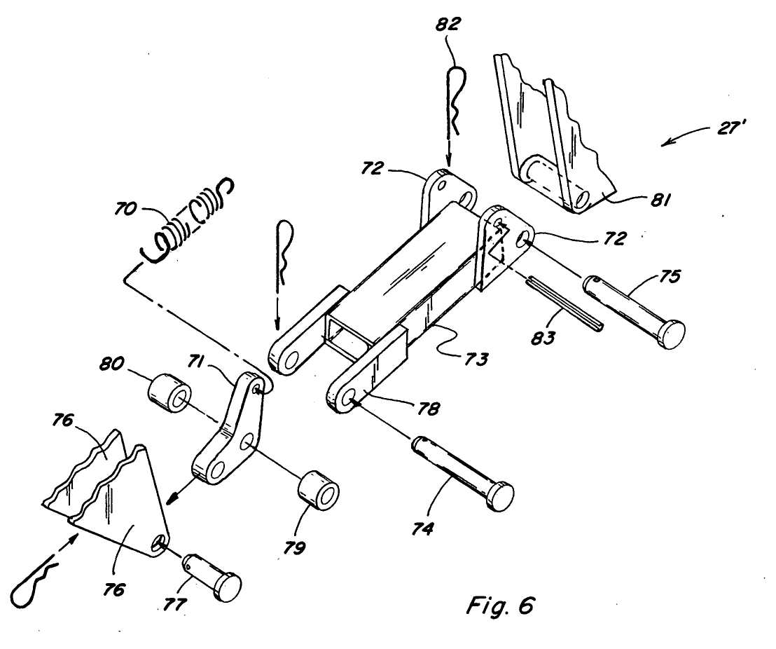

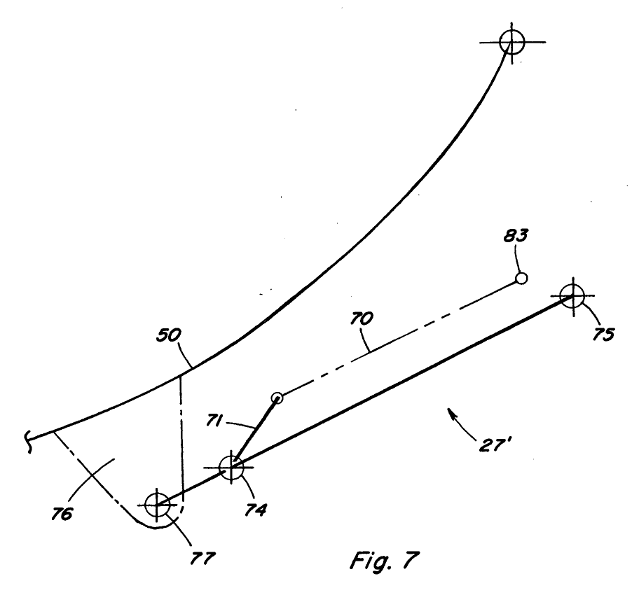

In FIGS. 5, 6 and 7, an alternative over-center linkage 27′ may be employed which provides more structural support and is more secure than the piston-type over-center linkage 27 shown in FIG. 4. The linkage 27′ of FIG. 5 is a two stroke hinged spring, which is under minimal tension. Its assembly can be more readily seen at FIG. 6 wherein spring 70 is stretched between hinged centrally mounted rocker member 71 and rod 75 which fits through ears 72. Carriage frame member 73 adds greater strength but also adds additional moving parts. Pin 74 allows rocker 71 and the carriage 73 and spring 70 to all move when plate 50 flexes from the pressure of wad 60 so as to increase the tension on spring 70. Rocker member 71 is secured at two points including support bracket 76 by virtue of pin 77 and at carriage bracket support arm 78 through spacers 79 and 80 which rotatably receive pin 74. Carriage frame member 73 is secured to the distributor 26 by bracket support 81 through which pin 75 extends for securing within ears 72, the support member 81. Presto pin 82 secures rod 83 enabling spring 70 to securely have tension and bias.

The threshold pressure, under which the hinging or moving of the deflector plates is initiated, will vary depending upon the conditions of the harvested field and the types of residual clumps which are anticipated. The size of the springs, hinges, cams, rockers, yokes, etc. may also vary and such sizes are integrally coordinated to yield the desired threshold action. For example, a preferred range of threshold pressures is from 33 psi at 300 rpm impeller speed to about 130 psi at 800 rpm; but a range of 41 psi at 300 rpm to 108 psi at 800 rpm is particularly preferred.

The threshold pressure is that pressure exerted within the spreader, and particularly on the deflector plates, at the point-in-time that wadded crop residue plugs up or stalls the impellers going at a particular speed, but prior to the occurrence of overly excessive damage. The faster the impellers are revolving, the greater the pressure will be at the point-in-time of stalling. For example, Table 1 below charts the ranges of threshold pressures (psi) at particular revolutions per minute (rpm), and provides a preferred threshold pressure within that range.

TABLE 1

| | |
|---|---|
| Preferred | Range Of Pressures |

| Speed | Pressure | Min | Max |
|---|---|---|---|
| RPM | psi | psi | psi |
| 300 | 41 | 33 | 49 |
| 400 | 54 | 43 | 65 |
| 500 | 68 | 54 | 82 |
| 600 | 81 | 65 | 97 |
| 700 | 95 | 76 | 114 |
| 800 | 108 | 86 | 130 |

For hydraulically driven spreaders, the spreader hydraulic circuit is preferably programmed to initiate and control the reflexing by a hydraulic feedback circuit. The deflector plates respond to sensing, for example, the above-described conditions of speed and/or pressure.

Alternatively, and more simplistic but less preferred, modes of operation are employed on spreaders which sense only impeller speeds. Release mechanisms are employed for activating the reflexing action automatically when impeller speeds drop by a threshold amount, preferably a drop of about 80% of the original speed. One advantage of the speed-type method may be that sensing the speed, to initiate the reflex action, enables use of pre-existing monitors and sensors rather than installing an add-on hydraulic feedback circuit.

A still further alternative for controlling the threshold reflexing action is to adjust the spring tension, in the over-center linkage, manually, in accordance with whatever impeller speed setting is selected by the operator.

While the present invention has been described with reference to certain preferred embodiments, one of ordinary skill in the art will recognize that additions, deletions, substitutions, modifications and improvements can be made while remaining within the spirit and scope of the present invention as defined by the appended claims.

What is claimed is:

1. An improved vertical spreader for a combine harvester, said spreader having dual counter-rotating impellers with a circumferential profile, and said spreader comprising:
laterally extending deflector elements, pivotally projecting outwardly from a centrally located flow guide element, said deflectors elements having arcuate profiles matching the circumferential profiles of the dual counter-rotating impellers rotatably affixed within the spreader and generally intermediately adjacent to the deflector elements, but having a predetermined clearance between said propellers and said deflectors to allow said propellers to rotate unimpededly; and having
over-center linkages reinforcing the deflector against the flow guide element, being spring loaded and biased against the pivotal movement of the deflector elements, said bias being commensurate with a predetermined threshold pressure to be exerted by wadded crop residue being circumferentially propelled by the aforesaid dual impellers; and
said linkages also having a stop and hold element for the deflector elements to return and hold at the predetermined point of clearance, upon reflex action from the spring bias.

2. The improved vertical spreader of claim 1, having a predetermined threshold pressure of its deflector reflex, of from about 33 psi at 300 rpm to about 130 psi at 800 rpm.

3. The spreader of claim 1 having deflector elements being selected from the group consisting of plates, sheets, rib elements, forked-members, and the like.

4. The spreader of claim 1 having adjustable flow guide elements.

5. The spreader of claim 1 wherein the deflector elements are hinged at the flow guides.

6. The spreader of claim 5 wherein the hinges are leaf springs.

7. The vertical spreader of claim 1 having an over-center linkage comprising:
a) a first end and an opposite end;
b) a piston element; and
c) a spring member coiled around the spring; and
said piston element having a piston guide chamber extending from a stop end hingedly connected to a stop on the deflector element, and slidably within a hollow bore throughout the length of the chamber is a piston rod whose sliding action terminates and holds at the stop; and
said spring member being telescopically coiled around said piston element.

8. The vertical spreader of claim 1 having an over-center linkage comprising:
a rocker type linkage reinforcing the stop and hold between the deflector element and the flow guide element, being characterized by spring biased between hinged rocker element and a stop hingedly secured to the flow guide element.

9. The vertical spreader of claim 1 wherein the threshold pressure is the pressure exerted within the spreader on the deflector elements at a point where wadded crop residue plugs up and stalls the impellers but prior to occurrence of overly excessive damage.

10. The vertical spreader of claim 1 wherein the reflexing action is initiated hydraulically.

11. The vertical spreader of claim 1 wherein the threshold pressure corresponds to a slowing of the speed of the impellers by a drop of about 80% of the original speed.

12. The vertical spreader of claim 1 wherein the threshold for the reflexing action is achieved manually by adjusting the over-center linkage to a tension corresponding to a predetermined impeller speed or a predetermined pressure.

13. A method for spreading crop residue from a combine harvester, the method comprising providing a spreader having automatically reflexing deflector elements, which reflexing activity is initiated by sensing positive pressure from wadded crop residue and/or by sensing loss of impeller speed.

14. The spreader of claim 2 having a range of speed dependent threshold pressures selected from the group consisting of 33 to 49 psi at 300 rpms, 43 to 65 psi at 400 rpms, 54 to 82 psi at 500 rpms, 65 to 97 psi at 600 rpms, 76 to 114 psi at 700 rpms, and 86 to 130 psi at 800 rpms.
